(19) United States
(12) Patent Application Publication
(10) Pub. No.: US 2004/0264051 A1
(43) Pub. Date: Dec. 30, 2004

(54) Slider and fabrication of a trailing edge therefor

(75) Inventors: Michael John Gronseth, Bloomington, MN (US); Ladislav Rudolf Pust, Savage, MN (US)

Correspondence Address: Deirdre Megley Kvale, Westman, Champlin & Kelly, Suite 1600, 900 Second Avenue South, Minneapolis, MN, 55402-3319, US

(73) Assignee: Seagate Technology LLC, Scotts Valley, CA

(21) Appl. No.: 10/608,969

(22) Filed: Jun. 27, 2003

(51) Int. Cl. G11B 5/60

(52) U.S. Cl. 360/235.7

(57) ABSTRACT

A slider including a trench fabricated in an overcoat layer of a transducer portion of the slider is disclosed. The trench forms a recessed trailing edge of the slider. The trailing edge is recessed a dimension defined by an etched depth of the trench to define a close point of the slider within desired operational parameters for read and/or write operations.

### FIELD OF THE INVENTION

The present invention relates generally to a data storage device or system, and more particularly but not by limitation to fabrication of heads for a data storage device or system.

### BACKGROUND OF THE INVENTION

Data storage devices store digitally encoded information on discs. Heads read data from or write data to discs which are supported for rotation relative to a base chassis by a spindle motor or drive. Heads include transducer elements, such as magnetoresistive, magneto-optical or inductive elements for read or write operations. An actuator assembly moves the heads relative to select data tracks on the disc for read or write operations.

Typically the head includes a slider which is coupled to a head suspension assembly. Rotation of the disc creates an air flow under the slider or head to provide a lift force via pressurization of air bearing surfaces of the slider. The lift force of the slider is countered by a load force supplied via the suspension assembly to define in part a fly height H_{fly} of the slider relative to the disc surface. The slider is coupled to the head suspension assembly via a gimbal spring so that the slider pitches and rolls to follow the topography of the disc surface. The slider generally flies at a pitch angle so that a trailing edge of the slider defines a close point of the slider relative to the disc surface. The fly height H_{fly} of the trailing edge is generally above a glide avalanche height of the disc to limit slider-disc contact.

The fly height H_{fly} parameters of the head effect the spacing between the transducer elements of the head and a magnetic or data layer of the disc. Data storage densities are increasing requiring smaller spacing between the transducer elements and the disc (magnetic or data layer) for desired read or write resolution and clarity. Reductions in spacing between the transducer elements and the disc is limited by the fly height H_{fly} of the slider above the glide avalanche height of the disc. Embodiments of the present invention provide solutions to these and other problems, and offer other advantages over the prior art.

### SUMMARY OF THE INVENTION

The present invention relates to a slider having a trench formed in an overcoat layer of the transducer or transducer portion. The trench forms a recessed trailing edge of the slider which is recessed a dimension defined by an etched depth of the trench. The recessed trailing edge defined by the etched depth of the trench defines a close point of the slider within desired operational parameters for read and/or write operations. Other features and benefits that characterize embodiments of the present invention will be apparent upon reading the following detailed description and review of the associated drawings.

### BRIEF DESCRIPTION OF THE DRAWINGS

FIG. 1 is a perspective illustration of a data storage device or system.

FIG. 2 diagrammatically illustrates a slider relative to a disc surface.

FIG. 3 illustrates a slider and transducer portion having a recessed trailing edge.

FIG. 4 schematically illustrates fabrication of a recessed trailing edge relative to a raised bearing surface of the slider.

FIG. 5 illustrates a recessed trailing edge having a recessed dimension defined by a trench formed relative to a trailing end surface of the slider.

FIGS. 6-7 illustrate fabrication of an etched or milled trench to form a recessed trailing edge relative to a trailing end surface of the slider.

FIG. 8 illustrates a wafer fabrication process for sliders.

FIG. 9 illustrates process steps for wafer fabrication of a trench forming a recessed trailing edge of the slider.

### DETAILED DESCRIPTION OF ILLUSTRATIVE EMBODIMENTS

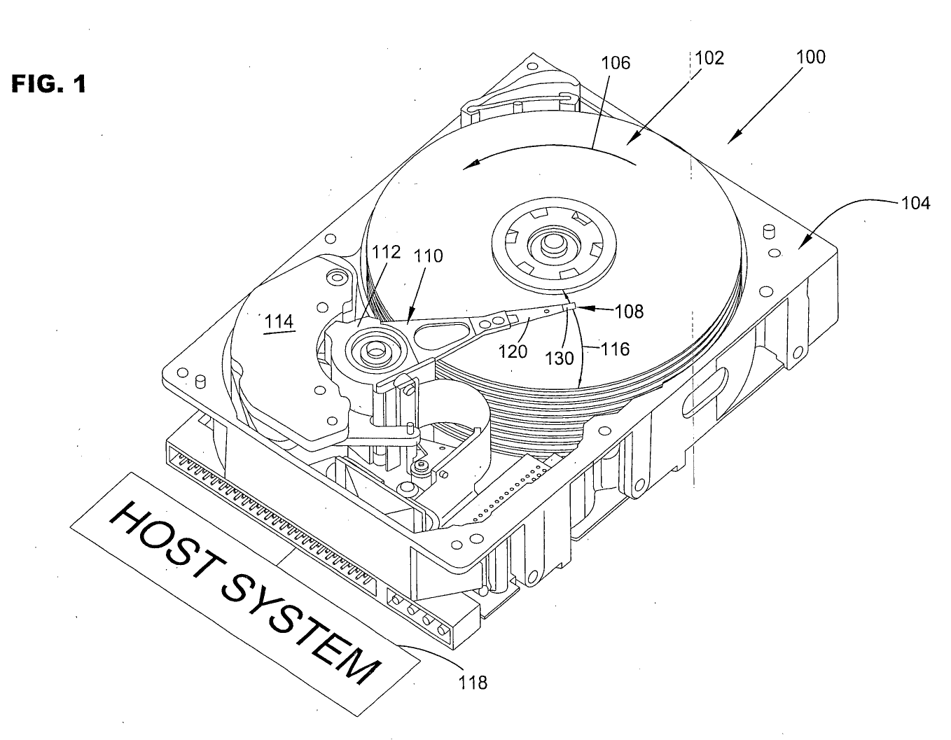

FIG. 1 is a perspective illustration of a data storage device 100 in which embodiments of the present invention are useful. Device 100 includes a plurality of discs 102 rotationally coupled to a base chassis 104 via a spindle motor (not shown) as illustrated by arrow 106. Heads (such as for example, magnetoresistive, magneto-optical or inductive heads) are coupled to an actuator assembly 110 to position the heads 108 to read data from or write data to the discs 102. In the embodiment shown, the actuator assembly 110 includes an actuator 112 which is rotated via operation of a voice coil motor (VCM) 114 to move the head 108 as illustrated by arrow 116 relative to selected tracks on the disc 102 based upon commands or signals from a host computer or system 118 (illustrated schematically).

In the embodiment shown, the head 108 is coupled to the actuator 112 via a head suspension assembly 120 and a gimbal spring (not shown) to allow the head 108 to pitch and roll to follow the topography of the disc surface. Rotation of the disc creates an air flow under a slider 130 of the head to provide a lifting force via pressurization of air bearing surfaces of the slider (i.e. raised bearing surfaces). The lifting force is countered by a load force of the suspension assembly 120 to define in part a fly height of the head 108 above the disc surface.

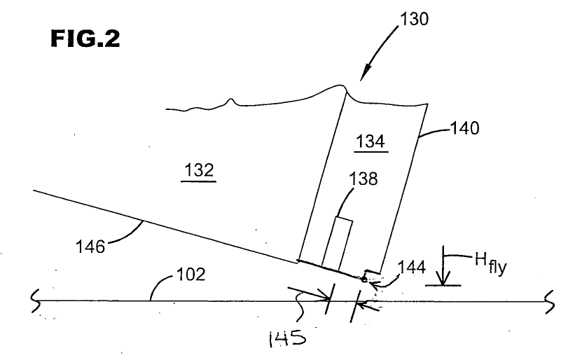

As shown in FIG. 2 the slider 130 includes a substrate or body 132 such as for example an Al₂O₃-TiC substrate and a transducer portion 134 fabricated proximate to the trailing edge of the slider 130. Transducer portion 134, includes transducer elements 138 for example, a read sensor (such as a magnetoresistive element) and a write element (such as an inductive coil) illustrated schematically, and an overcoat protective layer. The transducer elements 138 are typically embedded in a material, such as an Alumina Al₂O₃ material and are recessed or spaced from a trailing end surface 140 of the slider.

Disc drive density is increasing requiring smaller spacing between the transducer elements and the magnetic recording layer or data layer on the disc surface (i.e. head-media spacing) for desired read write resolution or clarity.

Reductions in head-media spacing are restricted by physical fly height H_{fly} characteristics between the slider and the disc surface. As shown, the slider typically flies at a pitch angle such that a trailing edge 144 of the slider flies closer to the disc surface than the leading edge (not shown in FIG. 2) and defines a close point between the slider and disc surface. Slider fly heights H_{fry} (i.e. fly height of the trailing edge 144) below a glide avalanche height of the disc can result in massive head-disc contact degrading read or write operations. Head media spacing parameters are confined by the fly height H_{fly} of trailing edge 144 of the slider and the spacing 145 between the trailing edge 144 and the recessed transducer element(s) 138.

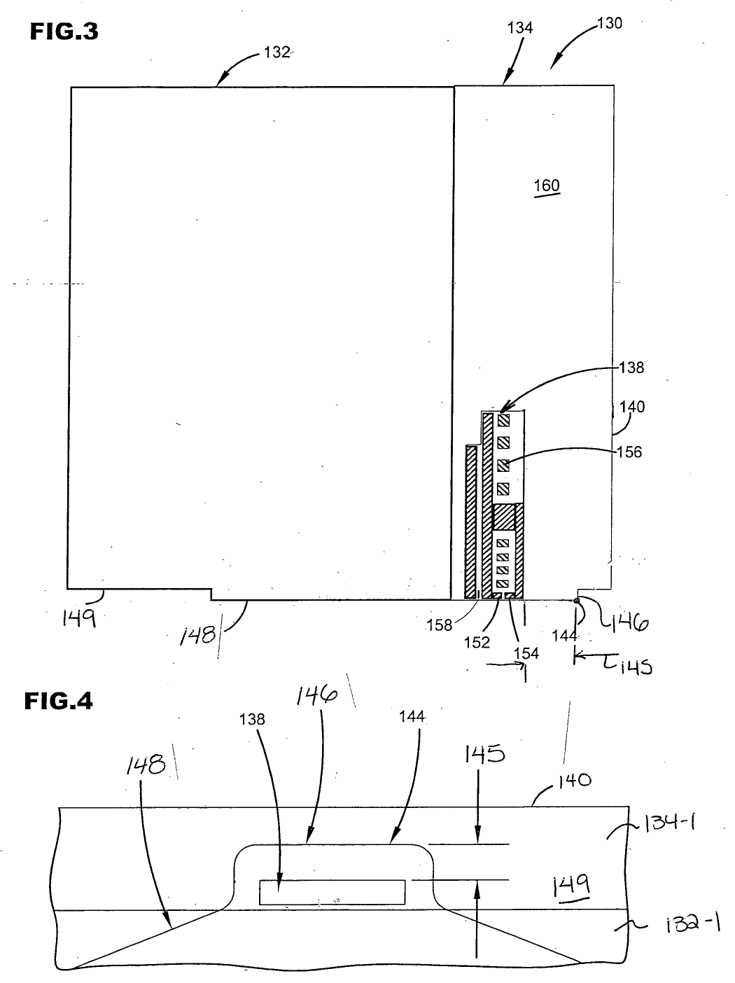

In slider embodiments shown in FIGS. 3-4, the trailing edge 144 of the slider is recessed from a trailing end surface 140 of the slider and is formed via a trailing edge 146 of a raised bearing surface 148 elevated above recessed surfaces 149 of the slider. In particular, the recessed trailing edge 144 is formed via fabrication of the raised bearing surface 148 on the slider (or transducer portion) by known bearing mask or fabrication processes. Bearing fabrication process limitations make it difficult to control placement of the recessed trailing edge 144 or distance dimension 145 relative to the transducer elements 138 since accuracy of the position of the recessed trailing edge 144 relative to the transducer elements 138 is limited by the processes used to align mask layers (i.e. photoalignment processes) of the air bearing or raised bearing surfaces 148 of the slider. Tolerance limitations regarding placement of the recessed trailing edge 144 relative to the transducer elements 138 and end surface 140 increase variations in operating parameters of the head.

In particular in the embodiment shown in FIG. 3, the transducer portion 134 includes an inductive transducer element (poles 152 and 154 and coil 156) and a sensor 158 (such as a magnetoresistive sensor illustrated diagrammatically) although application of the present invention is not limited to specific transducer element or elements shown. The transducer elements 138 are recessed from the trailing end surface 140 of the slider by an overcoat layer 160 of the transducer portion 134. The recessed position of the trailing edge 144 relative to end surface 140 reduces spacing 145 between the transducer elements and the close point of the slider. The recessed trailing edge (or bearing edge 146) is formed along the overcoat layer 160 and alignment of the mask for forming the bearing surface 148 and trailing edge 144 (with respect to the transducer elements and end surface 140) is more difficult for thinner overcoat layers 160.

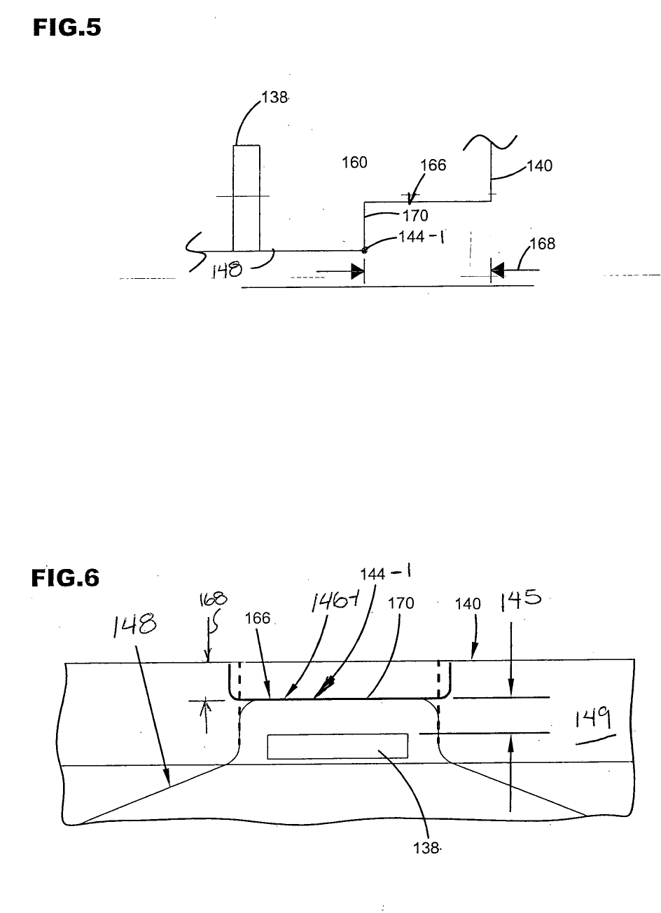

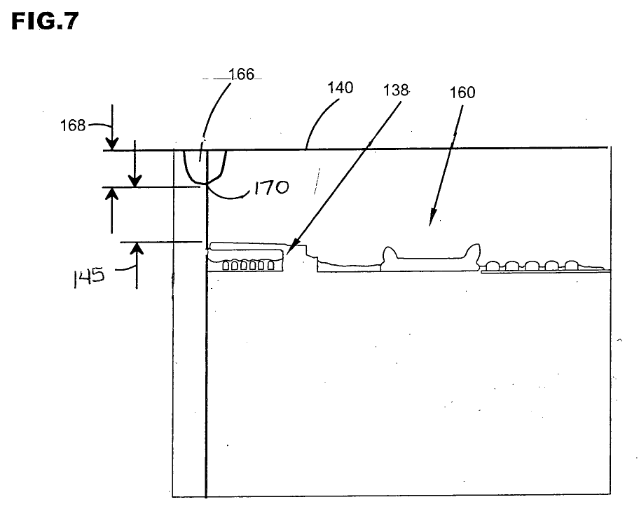

FIGS. 5-7 illustrate a slider having a trench 166 formed in the overcoat layer 160 (for example Alumina) of the transducer portion 134 where like numbers are used to refer to like parts in the previous FIGS. As shown in FIGS. 5-7, the recessed trailing edge 144-1 is formed via the trench 166 so that alignment of the recessed trailing edge 144-1 is determined by an etched depth 168 of the trench 166 relative to the trailing end surface 140 of the slider. As shown in FIG. 6, raised bearing surface or surfaces 148 of the slider are formed by known bearing masking processes. Recessed surface 170 of the trench 166 defines the trailing edge 146-1 for the raised bearing surface 148 and of the slider. Control of the etch depth 168 provides more accurate alignment of the recessed trailing edge 144-1 relative to the transducer elements 138 of the head (i.e. dimension 145) over prior processes where the recessed trailing edge is formed relative to raised bearing surfaces and placement depends upon alignment accuracy of the etched features of the raised and recessed bearing surfaces.

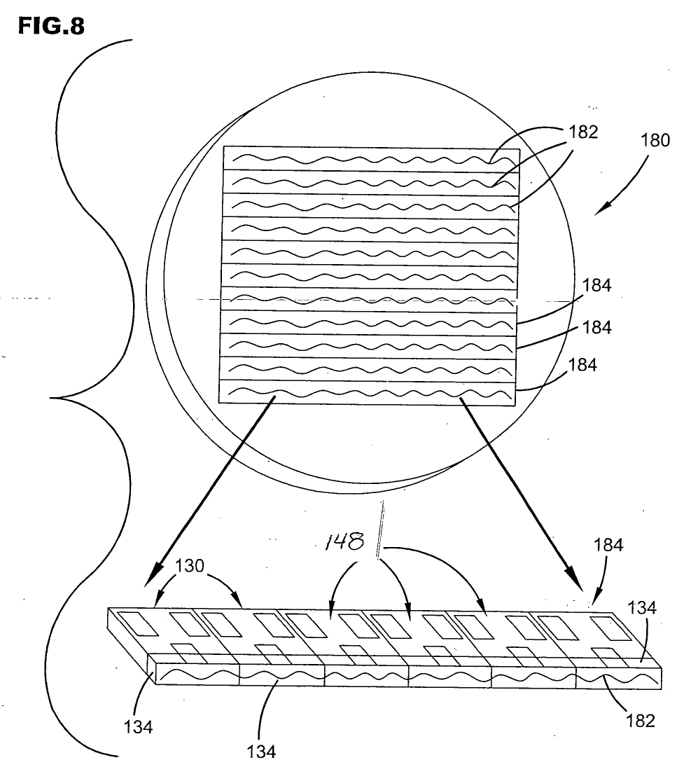

Sliders are typically fabricated from a substrate wafer 180, such as for example a Al₂O₃-TiC as shown in FIG. 8. As shown rows of transducers or elements 182 (illustrated diagrammatically) are deposited on the wafer 180 to form the transducer portion 134 extending from a surface of the wafer 180. The wafer 180 is cut into a plurality of slider bars 184 and an air bearing surface face of the bar is lapped or planarized to a proper level. Raised bearing surfaces 148 (or air bearing surfaces) are fabricated on the air bearing surface face of the slider bar 184 (along the surface cut from the wafer). In particular, the raised bearing surfaces 148 (or air bearing surfaces) are fabricated using a masking process where etched features are photoaligned to produced the desired surface contour. Prior slider embodiments have a recessed trailing edge 144 defined by the bearing surface masking or fabrication step of the slider bar (i.e. mask forming edge surface 146 of the raised bearing surface 148) which limits alignment or fabrication of the trailing edge 144.

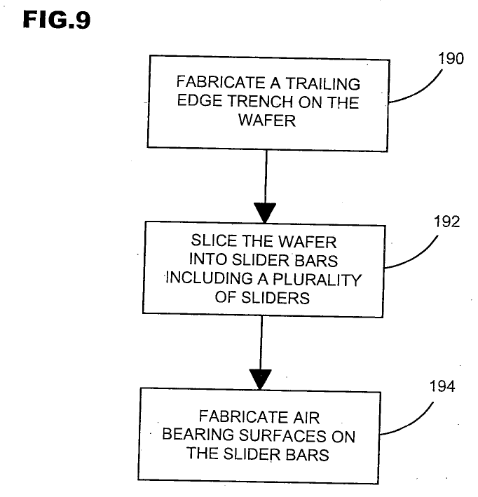

The present invention provides a recessed trailing edge 144-1 defined by an etched trench 166 relative to the trailing end surface 140 of the slider. FIG. 9 illustrates an embodiment of the present invention including wafer level fabrication of the trench 166 or trailing edge prior to slicing the wafer 180 into slider bars 184. As illustrated by block 190 of FIG. 9, trenches 166 are fabricated on the wafer 180 to form the recessed etched surface 170. In particular, the trenches 166 are etched after the transducer portion 134 is fabricated on the wafer and the surface of the transducer portion is planarized. Thereafter, the wafer 180 is sliced into slider bars 184 having the plurality of sliders therealong, as illustrated by block 192. Air bearing surfaces (e.g. raised or recessed bearing surfaces) 148 are fabricated on the plurality of sliders of the slider bar 184 as illustrated by block 194 by known fabrication or photoalignment masking processes. As described, the recessed etch surface 170 of trench 166 forms the trailing edge of the slider and spacing 145 relative to the transducer elements of the slider. Thus, as described, the trailing edge is fabricated on all the heads at the wafer level which is more efficient and less costly than fabrication at the slider bar level.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention. In addition, although the preferred embodiment described herein is directed to magnetic data storage device or system it will be appreciated by those skilled in the art that the teachings of the present invention can be applied to devices without departing from the scope and spirit of the present invention.

What is claimed is:

1. A method for fabricating a slider comprising the steps of:
fabricating a plurality of transducers on a wafer including an overcoat layer;
etching a trench in the overcoat layer; and
slicing the wafer into slider bars having a plurality of sliders formed therealong and fabricating air bearing surfaces for the plurality of sliders along the slider bar having a trailing edge defined by a recessed surface of the etched trench.

2. The method of claim 1 wherein the overcoat layer is an Alumina overcoat layer and the trench is formed in the Alumina overcoat layer.

3. The method of claim 1 wherein the air bearing surfaces of the plurality of sliders along the slider bar are formed using a photoalignment masking process.

4. The method of claim 1 wherein the recessed surface of the trench forms a trailing edge for a raised bearing surface of the slider.

5. The method of claim 1 and further comprising the step of:
planarizing the slider or wafer prior to etching the trench.

6. A method for fabricating a slider comprising the step of:
fabricating a trench having a recessed trench surface spaced from a trailing end surface of the slider to form a trailing edge of a raised bearing surface of the slider defined by an etched depth of the trench of the slider.

7. The method of claim 6 wherein the trench is fabricated at a wafer level prior to slicing the wafer into slider bars to form a plurality of sliders therealong.

8. The method of claim 7 and further comprising the step of:
forming air bearing surfaces on the slider bar after slicing the slider bar from the wafer.

9. A head comprising:
a slider having a transducer portion fabricated proximate a trailing end of the slider; and
a trench in an overcoat layer of the transducer portion forming a trailing edge of the slider and the trailing edge having a recessed dimension relative to a trailing end surface of the slider defined by an etched depth of the trench of the slider.

10. The head of claim 9 wherein the overcoat layer is an Alumina layer.

11. The head of claim 9 wherein the transducer portion includes inductive and/or magnetoresistive transducer elements.

12. The head of claim 9 wherein the trench forms a trailing edge of a raised bearing surface of the slider.
